(19) United States
(12) Patent Application Publication
(10) Pub. No.: US 2024/0396072 A1
(43) Pub. Date: Nov. 28, 2024

(54) ENERGY STORAGE CELL

(71) Applicant: TOYOTA JIDOSHA KABUSHIKI KAISHA, Toyota-shi (JP)

(72) Inventors: Takenori Ikeda, Owariasahi-shi (JP); Tomoyuki Uezono, Okazaki-shi (JP); Ryuta Sugiura, Toyota-shi (JP); Takeshi Abe, Okazaki-shi (JP); Yuki Takahashi, Miyoshi-shi (JP); Kenta Kimura, Toyota-shi (JP)

(73) Assignee: TOYOTA JIDOSHA KABUSHIKI KAISHA, Toyota-shi (JP)

(21) Appl. No.: 18/436,377

(22) Filed: Feb. 8, 2024

(30) Foreign Application Priority Data
May 22, 2023 (JP) 2023-083968

(51) Int. Cl. H01M 10/04

(52) U.S. Cl. CPC H01M 10/0431

(57) ABSTRACT

An energy storage cell includes an electrode assembly, a cell case housing the electrode assembly, and an electrolyte solution contained in the cell case. The electrode assembly includes a wound assembly obtained by winding a positive electrode sheet and a negative electrode sheet with a separator therebetween, a first tape attached to one end in an axial direction of the wound assembly, and a second tape attached to the other end in the axial direction of the wound assembly. A force of fixing the wound assembly by the first tape is smaller than a force of fixing the wound assembly by the second tape.

### CROSS-REFERENCE TO RELATED APPLICATION

This application claims priority to Japanese Patent Application No. 2023-083968filed on May 22, 2023, incorporated herein by reference in its entirety.

### BACKGROUND

### 1. Technical Field

The present disclosure relates to energy storage cells.

### 2. Description of Related Art

WO 2018/168628 discloses a non-aqueous electrolyte secondary battery including: a wound assembly obtained by winding a positive electrode sheet and a negative electrode sheet with a separator interposed therebetween; and a battery case containing the wound assembly and a non-aqueous electrolyte. The winding end of the wound assembly is fixed with tapes. Specifically, the tapes are attached to one end and the other end in the axial direction of the wound assembly.

### SUMMARY

In the non-aqueous electrolyte secondary battery described in WO 2018/168628, the electrolyte solution flows out of the wound assembly especially during high-rate charging and discharging. This may result in a shortage of the electrolyte solution in the wound assembly.

It is an object of the present disclosure to provide an energy storage cell that can reduce a shortage of an electrolyte solution in a wound assembly.

An energy storage cell according to one aspect of the present disclosure includes:
an electrode assembly;
a cell case housing the electrode assembly; and
an electrolyte solution contained in the cell case.

The electrode assembly includes
a wound assembly obtained by winding a positive electrode sheet and a negative electrode sheet with a separator interposed between the positive electrode sheet and the negative electrode sheet,
a first tape attached to one end in an axial direction of the wound assembly, and a second tape attached to another end in the axial direction of the wound assembly.

A force of fixing the wound assembly by the first tape is smaller than a force of fixing the wound assembly by the second tape.

According to the present disclosure, it is possible to provide an energy storage cell that can reduce a shortage of an electrolyte solution in a wound assembly.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view schematically showing an energy storage cell in an embodiment of the present disclosure;

FIG. 2 is a front view schematically showing the electrode assembly;

FIG. 3 is a sectional view of a first tape; and

FIG. 4 is a sectional view of a second tape.

### DETAILED DESCRIPTION OF EMBODIMENTS

An embodiment of the present disclosure will be described with reference to the drawings. The same or corresponding members are denoted by the same numerals throughout the figures that will be referred to below.

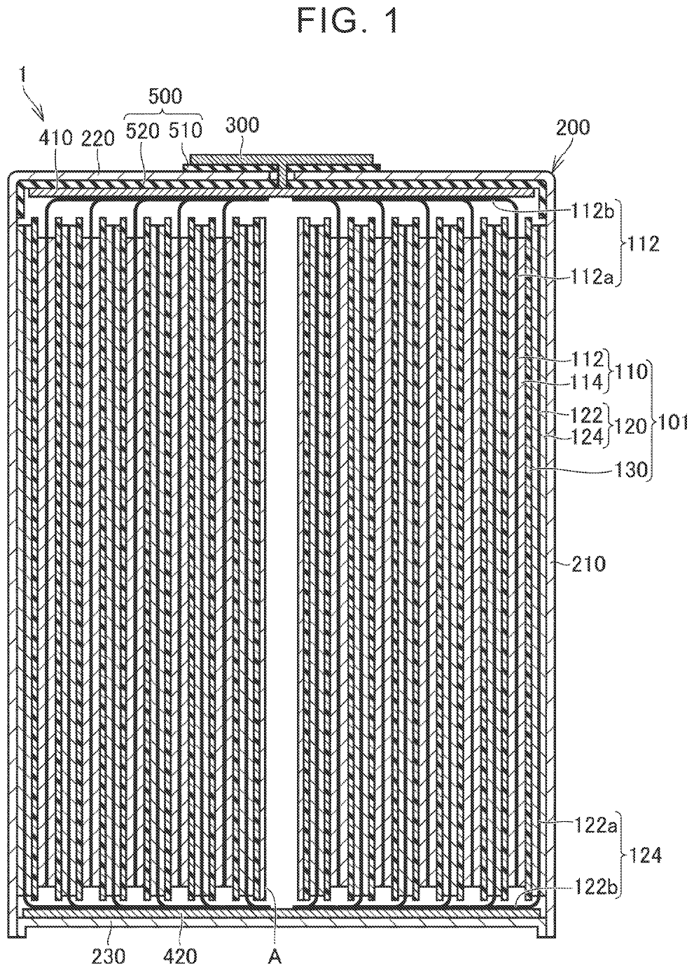

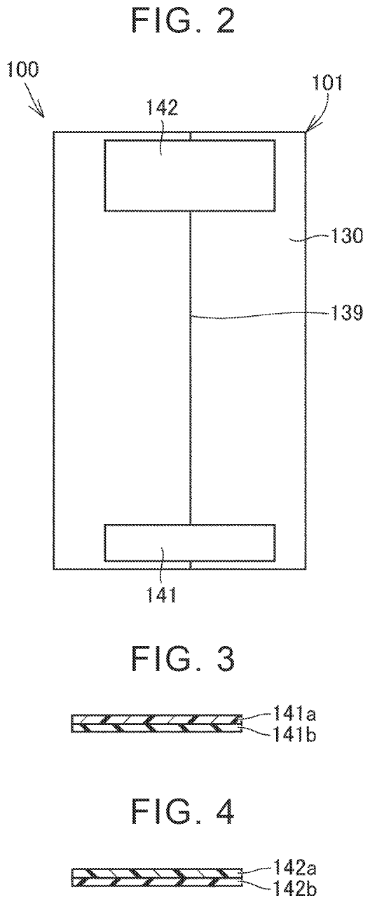

FIG. 1 is a partial sectional view schematically showing an energy storage cell in an embodiment of the present disclosure. FIG. 2 is a front view schematically showing the electrode assembly. This energy storage cell 1 is preferably mounted on a vehicle.

As shown in FIGS. 1 and 2, the energy storage cell 1 includes an electrode assembly 100, a cell case 200, an external terminal 300, a positive current collector plate 410, a negative electrode current collector plate 420, an insulating member 500, and an electrolyte solution (not shown).

As shown in FIG. 2, the electrode assembly 100 includes a wound assembly 101, a first tape 141, and a second tape 142.

The wound assembly 101 includes a positive electrode sheet 110, a negative electrode sheet 120, and a separator 130. The wound assembly 101 has a structure in which a positive electrode sheet 110 and a negative electrode sheet 120 are wound around a winding core A (see FIG. 1) with a separator 130 between the positive and negative electrode sheets 110, 120.

The positive electrode sheet 110 includes a positive electrode current collector foil 112 and a positive electrode active material layer 114.

The positive electrode current collector foil 112 is made of metal such as aluminum. The positive electrode current collector foil 112 has a main region 112a and an end region 112b.

The main region 112a is a region of the positive electrode current collector foil 112 where the positive electrode active material layer 114 is provided. As shown in FIG. 1, the main regions 112a are arranged so as to overlap each other in the radial direction of the electrode assembly 100 (the left-right direction in FIG. 1).

The end region 112b is a region of the positive electrode current collector foil 112 where the positive electrode active material layer 114 is not provided. As shown in FIG. 1, the end region 112b is formed outside (upper side in FIG. 1) of the main region 112a in the axial direction of the electrode assembly 100 (vertical direction in FIG. 1).

The end region 112b has a plurality of tabs separated from each other in the circumferential direction of the electrode assembly 100. Each tab 112b1 falls toward the inside in the radial direction. The top surface of each tab forms a substantially flat surface. A positive current collector plate 410 is connected to each tab by welding or the like.

The negative electrode sheet 120 includes a negative electrode current collector foil 122 made of metal such as copper, and a negative electrode active material layer 124 provided on the surface of the negative electrode current collector foil 122.

The structure of the negative electrode current collector foil 122 is substantially the same as the structure of the positive electrode current collector foil 112. Therefore, the description of the negative electrode current collector foil 122 will be simplified. That is, the negative electrode current collector foil 122 has a main region 122a and an end region 122b. A negative electrode active material layer 124 is provided in the main region 122a. The end region 122b is formed outside the main region 122a in the axial direction (lower side in FIG. 1). The end region 122b has a plurality of tabs separated from each other in the circumferential direction. Each tab falls radially inward. A negative electrode current collector plate 420 is connected to each tab by welding or the like.

Separator 130 is arranged between positive electrode sheet 110 and negative electrode sheet 120. More specifically, the separator 130 is arranged only between the main region 112a of the positive electrode sheet 110 and the main region 122a of the negative electrode sheet 120 that are radially adjacent to each other. Separator 130 is made of an insulating material and allows ions to pass through.

The first tape 141 is attached to one end in the axial direction (vertical direction in FIG. 2) of the wound assembly 101. The second tape 142 is attached to the other end in the axial direction of the wound assembly 101. In this embodiment, the first tape 141 is provided below the second tape 142 in the vertical direction. That is, the first tape 141 is attached to the lower end of the wound assembly 101. The second tape 142 is attached to the upper end of the wound assembly 101. As shown in FIG. 2, the first tape 141 and the second tape 142 are attached to the wound assembly 101 so as to straddle the terminal end 139 of the wound assembly 101. The first tape 141 and the second tape 142 may be connected in an annular shape in the circumferential direction of the wound assembly 101.

As shown in FIG. 3, the first tape 141 includes a first base material layer 141a and a first adhesive layer 141b provided on the first base material layer 141a. The first base material layer 141a is made of, for example, polypropylene (PP), polyimide (PI), polyethylene (PE), polyethylene terephthalate (PET), polyphenylene sulfide (PPS), or the like. The first adhesive layer 141b is made of, for example, an acrylic or silicone adhesive.

As shown in FIG. 4, the second tape 142 includes a second base material layer 142a and a second adhesive layer 142b provided on the second base material layer 142a. The second base material layer 142a is made of the same material as the first base material layer 141a. The second adhesive layer 142b is made of the same material as the first adhesive layer 141b.

The force of fixing the wound assembly 101 by the first tape 141 is smaller than the force of fixing the wound assembly 101 by the second tape 142. In this embodiment, as shown in FIG. 2, the adhesive area of the first adhesive layer 141b to the wound assembly 101 is set to be smaller than the adhesive area of the second adhesive layer 142b to the wound assembly 101.

However, the adhesive area of the first adhesive layer 141b to the wound assembly 101 and the adhesive area of the second adhesive layer 142b to the wound assembly 101 may be set to be equal to each other. The adhesive force of the first adhesive layer 141b may be set to be smaller than the adhesive force of the second adhesive layer 142b. For example, when each adhesive layer 141b, 142b is made of a silicone-based adhesive, the mixing ratio of silicone rubber having a function of ensuring adhesion and silicone resin ensuring adhesion in each adhesive layer 141b, 142b may be different. That is, the mixing ratio of silicone resin in the first adhesive layer 141b may be set smaller than the mixing ratio of silicone resin in the second adhesive layer 142b. Alternatively, the molecular weight of the polymer in the first adhesive layer 141b may be set smaller than the molecular weight of the polymer in the second adhesive layer 142b.

The cell case 200 houses the electrode assembly 100. An electrolyte solution (not shown) is contained in the cell case 200. The cell case 200 is sealed. The cell case 200 is made of metal such as aluminum. The cell case 200 has a cylindrical portion 210, a top wall 220, and a bottom wall 230.

The cylindrical portion 210 surrounds the outer peripheral surface of the electrode assembly 100.

The top wall 220 is connected to the upper end of the cylindrical portion 210. A through hole for inserting the external terminal 300 is formed in the center of the top wall 220.

The bottom wall 230 is connected to the lower end of the cylindrical portion 210 by welding or the like. The bottom wall 230 is in contact with the negative electrode current collector plate 420.

External terminal 300 is formed above the top wall 220. In this embodiment, the external terminal 300 constitutes a positive external terminal. The cell case 200 constitutes a negative external terminal.

The insulating member 500 insulates between the cell case 200 and the external terminal 300. The insulating member 500 has an upper insulating portion 510 and a lower insulating section 520.

The upper insulating portion 510 is provided on the upper surface of the top wall 220. The upper insulating portion 510 is interposed between the upper surface of the top wall 220 and the external terminal 300.

The lower insulating section 520 is provided on the lower surface of the top wall 220. Lower insulating section 520 is interposed between positive electrode current collector plate 410 and cell case 200.

As described above, in the energy storage cell 1 according to the present embodiment, the force of fixing the wound assembly 101 by the first tape 141 is smaller than the force of fixing the wound assembly 101 by the second tape 142. Therefore, the electrolyte solution holding space at one end of the wound assembly 101 is larger than the electrolyte solution holding space at the other end of the wound assembly 101. Therefore, the electrolyte solution that has flowed out from the wound assembly 101 during charging and discharging, etc., tends to return to the wound assembly 101 again. Therefore, the shortage of electrolyte solution in the wound assembly 101 is suppressed.

It will be appreciated by those skilled in the art that the exemplary embodiments described above are specific examples of the following aspects.

### First Aspect

An energy storage cell includes an electrode assembly, a cell case housing the electrode assembly, and an electrolyte solution contained in the cell case. The electrode assembly includes a wound assembly, a first tape, and a second tape. The wound assembly has a structure in which a positive electrode sheet and a negative electrode sheet are wound with a separator therebetween. The first tape is attached to one end in an axial direction of the wound assembly. The second tape is attached to the other end in the axial direction of the wound assembly. A force of fixing the wound assembly by the first tape is smaller than a force of fixing the wound assembly by the second tape.

In this energy storage cell, the force of fixing the wound assembly by the first tape is smaller than the force of fixing the wound assembly by the second tape. Therefore, the electrolyte solution holding space at one end of the wound assembly becomes larger than the electrolyte solution holding space at the other end of the wound assembly. Therefore, the electrolyte solution that has flowed out of the wound assembly during charging and discharging, etc., easily returns to the wound assembly. Therefore, a shortage of an electrolyte solution in the wound assembly is suppressed.

### Second Aspect

In the energy storage cell according to the first aspect, the first tape is located below the second tape in the vertical direction.

In this aspect, the electrolyte solution holding space is relatively large in the lower part of the wound assembly. Therefore, the electrolyte solution accumulated in the lower part of the cell case easily flows into the wound assembly from the lower part of the wound assembly.

### Aspect 3

In the energy storage cell according to the first or second aspect, the first tape includes a first adhesive layer. The second tape includes a second adhesive layer. An adhesive area of the first adhesive layer to the wound assembly is smaller than an adhesive area of the second adhesive layer to the wound assembly.

In the present embodiment, the adhesive area of the adhesive layer to the wound assembly varies between the adhesive layers. Therefore, the force of fixing the wound assembly by the first tape is smaller than the force of fixing the wound assembly by the second tape.

### Fourth Aspect

In the energy storage cell according to the first or second aspect, the first tape includes a first adhesive layer. The second tape includes a second adhesive layer. An adhesive force of the first adhesive layer to the wound assembly is smaller than an adhesive force of the second adhesive layer to the wound assembly.

In this embodiment, the adhesion strength of each adhesive layer to the wound assembly is different. Therefore, the force of fixing the wound assembly by the first tape is smaller than the force of fixing the wound assembly by the second tape.

Note that the embodiment disclosed herein is illustrative in all respects and should not be considered restrictive. The scope of the present disclosure is indicated by the claims rather than the description of the embodiment described above, and includes all modifications within the meaning and scope equivalent to the claims.

What is claimed is:

1. An energy storage cell comprising:
an electrode assembly;
a cell case housing the electrode assembly; and
an electrolyte solution contained in the cell case, wherein:
the electrode assembly includes
a wound assembly obtained by winding a positive electrode sheet and a negative electrode sheet with a separator interposed between the positive electrode sheet and the negative electrode sheet,
a first tape attached to one end in an axial direction of the wound assembly, and
a second tape attached to another end in the axial direction of the wound assembly; and
a force of fixing the wound assembly by the first tape is smaller than a force of fixing the wound assembly by the second tape.

2. The energy storage cell according to claim 1, wherein the first tape is located below the second tape in a vertical direction.

3. The energy storage cell according to claim 1, wherein:
the first tape includes a first adhesive layer;
the second tape includes a second adhesive layer; and
an adhesive area of the first adhesive layer to the wound assembly is smaller than an adhesive area of the second adhesive layer to the wound assembly.

4. The energy storage cell according to claim 1, wherein:
the first tape includes a first adhesive layer;
the second tape includes a second adhesive layer; and
an adhesive force of the first adhesive layer to the wound assembly is smaller than an adhesive force of the second adhesive layer to the wound assembly.
